(19) United States
(12) Patent Application Publication
(10) Pub. No.: US 2004/0149091 A1
(43) Pub. Date: Aug. 5, 2004

(54) Structure of a screwdriver tip

(76) Inventor: Ming-Chieh Hsu, Chino Hills, CA (US)

Correspondence Address: Ming-Chieh, Hsu, 4972 Heritage Drive, Chino Hills, CA, 91709, US

(21) Appl. No.: 09/759,783

(22) Filed: Jan. 16, 2001

(51) Int. Cl. B25B 23/00

(52) U.S. Cl. 81/438

(57) ABSTRACT

An improved structure of a screwdriver tip comprising a screwdriver shaft and a screwdriver tip, a circular hole being provided on the top face of the shaft body of the screwdriver shaft, closing to the front end thereof, and the shaft body being hollow for the insertion of the rod of the screwdriver tip, a cavity of an appropriate depth being provided at the rear end top face of the rod of the screwdriver tip, the cavity corresponding to the circular hole of the shaft body of the screwdriver, allowing the mounting of an elastic pad body, characterized in that the center of the top face of the elastic pad body is provided downwardly with a mounting hole for the insertion rod located below the bottom portion of the protruded stopper, the top portion of the insertion rod of the protruded stopper is extended to mount with a circular body having the top portion being extended with a circular protruded block having a recessed hole, the protruded stopper and the elastic pad body are insertably and securely connected and the elastic pad body is mounted at the cavity hole of the rod of the screwdriver tip such that the circular protruded block is extended to the exterior of the cavity hole, such that when the rod of the screwdriver tip is inserted into the shaft of the screwdriver, a pointed member is urged at the recessed hole of the circular protruded block to urge the elastic pad body to retract, the retraction of the protruded stopper allows the top face of the circular protruded block to smoothly push to the interior of the rod body, and when the circular protruded block is pushed to the circular hole of the shaft body, the elastic pad body urges upward the protruded block is extended into the circular hole, and the circular body of the protruded stopper is exactly urged the inner face of the circular hole to stop the rod of the screwdriver tip from continuously inserted with the shaft body of the screwdriver shaft, and the screwdriver tip is fully insertably connected to the front end of the shaft body of the screwdriver shaft, thereby allowing the interchangeable of screwdriver tips.

### BACKGROUND OF THE INVENTION

(a) Technical Field of the Invention

The present invention relates to structure of a screwdriver, and in particular, the tip of a screwdriver, which can be replaced with other types and shapes of the tips.

(b) Description of the Prior Art

FIG. 1 shows a screw fastening device comprising a machine body A, a machine tube B, a moving seat C, a screwdriver D, a pin slot seat E and a pin-triggering block F. This type of screw fastening device is also alike the conventional structure as shown in FIG. 2, wherein the front end of the tip D has a tip head D1. The drawback of these conventional art is that after a period of use, the mutual friction between the tip D1 and the screw G1 will cause serious wear out, in particular, at the tip D1. Thus, the fastening process may become abnormal. FIG. 3 is another conventional screwdriver E having a shaft body E1 with a recess E2. The drawback of this conventional screwdriver is that the steel ball H will automatically retract due to the urging force at the side of the cavity E3, and this will cause the tip F to dislocate from the front end of the shaft body E1, and it is rather inconvenience to the user.

Accordingly, a main object of the present invention is to provide an improved structure of a screwdriver tip, which overcomes the above-mentioned drawbacks.

### SUMMARY OF THE INVENTION

Accordingly, it is an object of the present invention to provide an improved structure of a screwdriver tip comprising a screwdriver shaft and a screwdriver tip, a circular hole being provided on the top face of the shaft body of the screwdriver shaft, closing to the front end thereof, and the shaft body being hollow for the insertion of the rod of the screwdriver tip, a cavity of an appropriate depth being provided at the rear end top face of the rod of the screwdriver tip, the cavity corresponding to the circular hole of the shaft body of the screwdriver, allowing the mounting of an elastic pad body.

Yet a further object of the present invention is to provide an improved structure of a screwdriver tip, characterized in that the center of the top face of the elastic pad body is provided downwardly with a mounting hole for the insertion rod located below the bottom portion of is the protruded stopper, the top portion of the insertion rod of the protruded stopper is extended to mount with a circular body having the top portion being extended with a circular protruded block having a recessed hole, the protruded stopper and the elastic pad body are insertably and securely connected and the elastic pad body is mounted at the cavity hole of the rod of the screwdriver tip such that the circular protruded block is extended to the exterior of the cavity hole, such that when the rod of the screwdriver tip is inserted into the shaft of the screwdriver, a pointed member is urged at the recessed hole of the circular protruded block to urge the elastic pad body to retract, the retraction of the protruded stopper allows the top face of the circular protruded block to smoothly push to the interior of the rod body, and when the circular protruded block is pushed to the circular hole of the shaft body, the elastic pad body urges upward the protruded block is extended into the circular hole, and the circular body of the protruded stopper is exactly urged the inner face of the circular hole to stop the rod of the screwdriver tip from continuously inserted with the shaft body of the screwdriver shaft, and the screwdriver tip is fully insertably connected to the front end of the shaft body of the screwdriver shaft, thereby allowing the interchangeable of screwdriver tips.

Other object and advantages of the present invention will become more apparent from the following description taken in conjunction with the accompanying drawing.

### BRIEF DESCRIPTION OF THE DRAWINGS

FIG. 1 is a schematic view of a conventional screw fastening device.

FIG. 2 is a schematic view of a screwdriver of a conventional screw fastening device.

FIG. 3 is a sectional view of the combination of the conventional screwdriver and the tip of the screwdriver.

FIG. 4 is a perspective exploded view showing the screwdriver shaft and the tip of the present invention.

FIG. 5 is a perspective exploded view of the tip, the elastic pad body and the protruded stopper of the present invention.

FIG. 6 is a sectional view of the screwdriver tip, the elastic pad body and the protruded stopper and the screwdriver shaft of the present invention.

FIG. 7 is a schematic view showing the withdrawal of the screwdriver shaft from the screwdriver tip of the present invention.

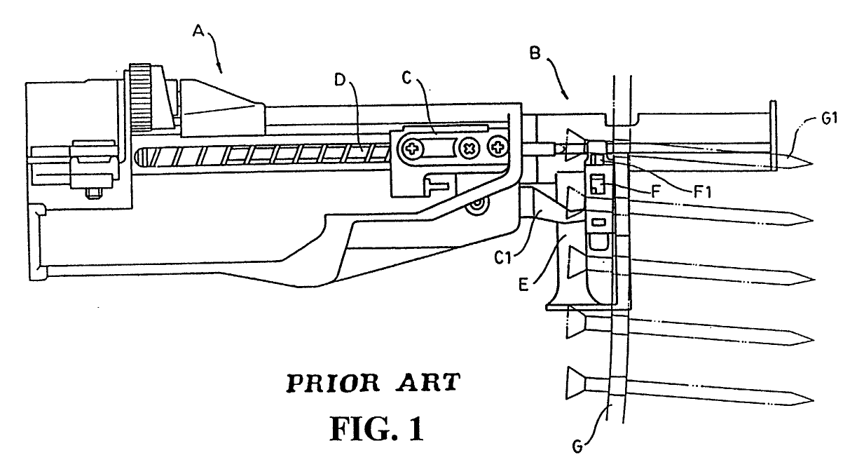

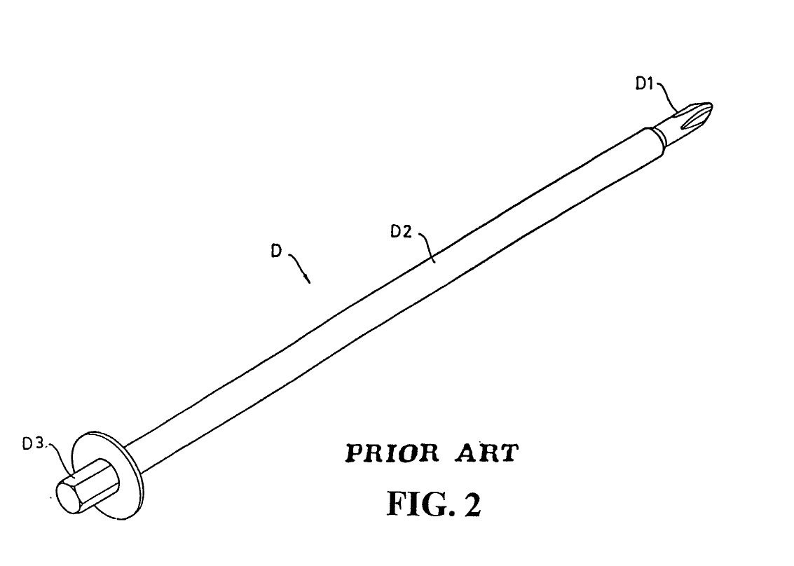

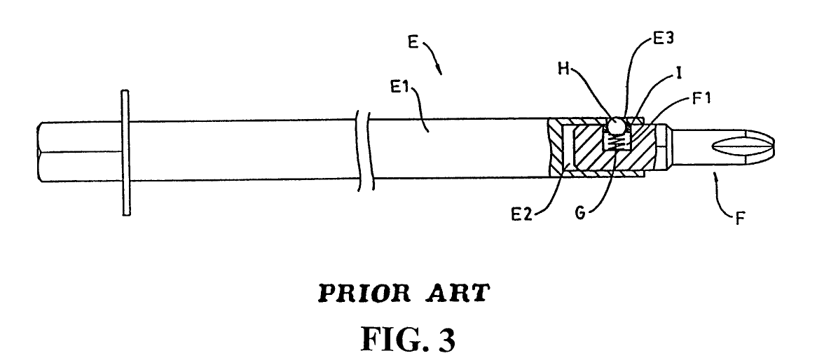

### DETAILED DESCRIPTION OF THE PREFERRED EMBODIMENT

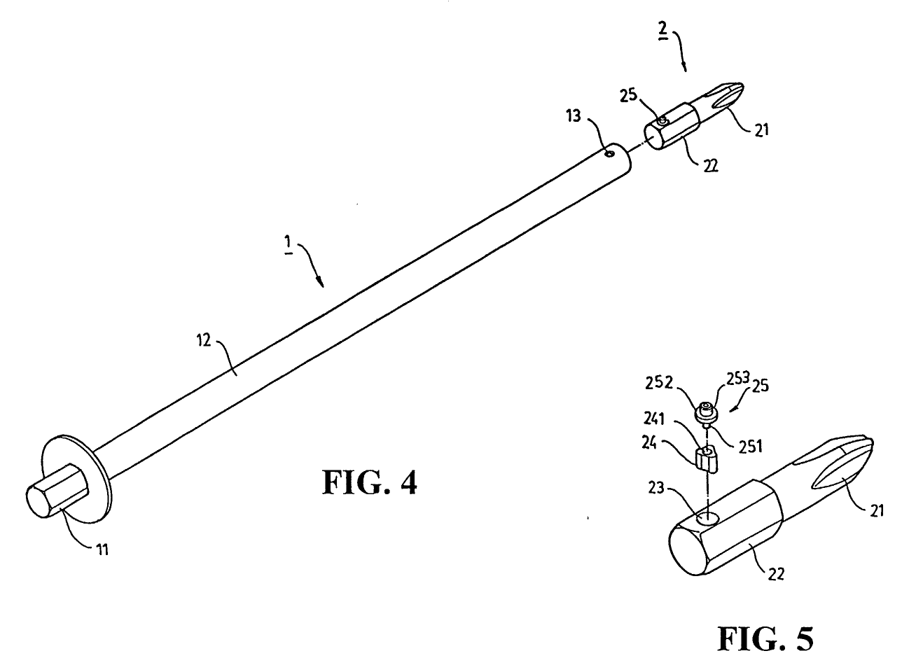

Referring to FIGS. 4 and 5, there is shown an improved structure of a screwdriver comprising a screwdriver shaft 1 and a tip 2. The rear end of the shaft 1 has a connection head 11, which can be connected with a rotating motor of a screw mounting device to provide a rotation movement. The extension of the front end of the connection head 11 is a circular shaft body 12. The interior of the shaft body 12 has a hollow hexagonal shape, and the top face, close to the front end of the shaft body 12, is provided with a circular hole 13. The circular hole 13 is for the mounting of the circular protruded block 253.

In accordance with the present invention, the tip 2 of the screwdriver is made from iron or steel material with a cross-shaped end head 21 to be urged at the cross-shaped screw nut for mounting. However, the rear section of the end head 21 is extended to form a hexagonal shaped shaft 22. The hexagonal shaft 22 can be inserted into the interior of the front end of the shaft body 12 of the screwdriver shaft 1 and the tip 2 and the screwdriver shaft 1 can be connected. The top face at the front end of the shaft 22 is provided internally with a cavity hole 23 of an appropriate depth. The cavity hole 23 is corresponding to the circular hole 13 of the screwdriver shaft 1, and the interior of the cavity hole 23 is inserted with an elastic pad body 24. The elastic pad body 24 is made from rubber material and is in a triangular shape. The volume of the elastic pad body 24 is slightly larger than that of the cavity hole 23 and with elasticity to be able to mount the interior of the cavity hole 23. Due to the triangular shape of the elastic pad body 24, there is a gap formed between the external surface of the elastic pad body 24 and the cavity hole 23 to allow the elastic pad body 24 to compress and to urge up and down. The center of the top face of the elastic pad body 24 is provided downwardly a mounting hole 241 for the insertion of a protruded stopper 25. The protruded stopper 25 is made from iron and steel material. The lower section of the center of the bottom portion of the protruded stopper 25 is provided with an insertion rod 251. The diameter of the insertion rod 251 is larger than the mounting hole 241 of the elastic pad body 24 such that the insertion rod 251 is firmly secured at the interior of the mounting hole 241 and will not be dislocated. The top portion of the insertion rod 251 is provided with a circular body 252 and the top portion by the circular body 252 is extended to form a circular protruded block 253 of appropriate height. The circular edge at the top face of the circular protruded block 253 is provided with a slanting face, and the center of the top portion of the circular protruded block 253 is provided with a recessed hole 254. Thus, when the insertion rod 251 of the protruded stopper 25 is closely mounted to the interior of the mounting hole 241 of the elastic pad body, the circular side at the bottom face of the circular body 252 is exactly urged at the top face of the elastic pad body 24. The elastic pad body 24 and the protruded stopper 25 are firmly secured together, and the elastic pad body 24 is then mounted at the interior of the cavity hole 23 of the shaft 22. Thus, the elastic pad body 24 and the protruded stopper can be mounted at the cavity hole 23 of the tip 2. The circular protruded block 253 can be inserted into the outside of the cavity hole 23. The shaft 22 of the tip 2 is inserted with the front end of the shaft body 12. When the circular protruded block 253 contacts the front end of the shaft body 12, the user can use a pointed article to urge the recessed hole 254 and a force is applied to compress the elastic pad body 24 and the protruded stopper 25 is driven by the elastic pad body 24 to lower and the circular protruded block 253 to smoothly slide into the shaft body 12. When the circular protruded block 253 is at the circular hole 13, with the elastic urging of the elastic pad body 24, the circular protruded block 253 is protruded upward to the circular hole 13. The circular body 253 of the lower section of the circular protruded block 253 can exactly urge the inner circular side of the circular hole 13 so as to restrict the shaft 22 of the tip 2 to move continuously and the tip 2 is fully mounted at the front end of the shaft body 12.

In view of the above, the present invention is characterized in that the center of the top face of the elastic pad body is provided downwardly with a mounting hole for the insertion rod located below the bottom portion of the protruded stopper, the top portion of the insertion rod of the protruded stopper is extended to mount with a circular body having the top portion being extended with a circular protruded block having a recessed hole, the protruded stopper and the elastic pad body are insertably and securely connected and the elastic pad body is mounted at the cavity hole of the rod of the screwdriver tip such that the circular protruded block is extended to the exterior of the cavity hole, such that when the rod of the screwdriver tip is inserted into the shaft of the screwdriver, a pointed member is urged at the recessed hole of the circular protruded block to urge the elastic pad body to retract, the retraction of the protruded stopper allows the top face of the circular protruded block to smoothly push to the interior of the rod body, and when the circular protruded block is pushed to the circular hole of the shaft body, the elastic pad body urges upward the protruded block is extended into the circular hole, and the circular body of the protruded stopper is exactly urged the inner face of the circular hole to stop the rod of the screwdriver tip from continuously inserted with the shaft body of the screwdriver shaft, and the screwdriver tip is fully insertably connected to the front end of the shaft body of the screwdriver shaft, thereby allowing the interchangeable of screwdriver tips.

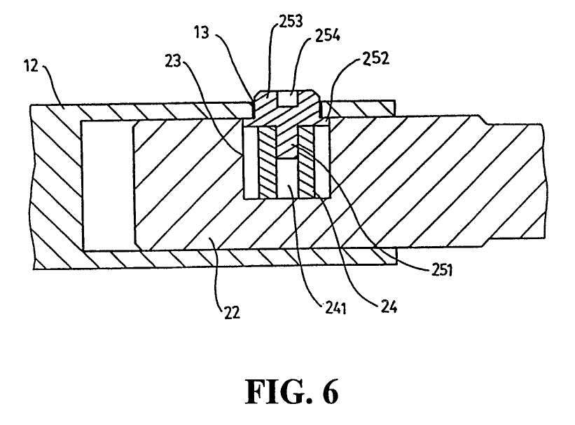

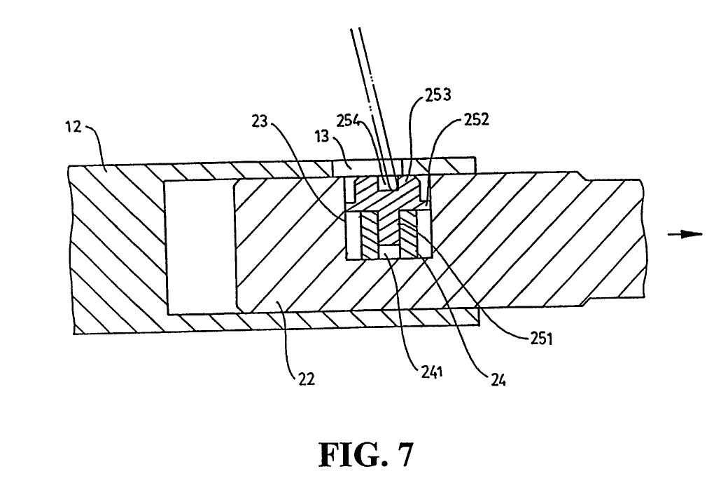

Referring to FIG. 6, there is shown the withdrawal of the tip of the screwdriver from the screwdriver shaft. As shown in the figure, the circular protruded block 253 is engaged at the circular hole 13 to restrict the tip 2 to be connected to the front end. To withdraw the tip 2, a pointed element is used to urge at the recessed hole 254 and a force is applied to squeeze the elastic pad body are connected at the bottom of the protruded stopper 25. This will cause the elastic pad body 24 to retract to drive the protruded block 25 to move downward. Due to the slanting face of the circular side of the circular protruded block 253, the circular protruded block 253 is smoothly pushed beyond the circular hole. Thus, the shaft 22 of the tip can be smoothly withdrawn from the front end of the shaft body 12. This will allow the user to change new tip 2.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

1. An improved structure of a screwdriver tip comprising a screwdriver shaft and a screwdriver tip, a circular hole being provided on the top face of the shaft body of the screwdriver shaft, closing to the front end thereof, and the shaft body being hollow for the insertion of the rod of the screwdriver tip, a cavity of an appropriate depth being provided at the rear end top face of the rod of the screwdriver tip, the cavity corresponding to the circular hole of the shaft body of the screwdriver, allowing the mounting of an elastic pad body, characterized in that the center of the top face of the elastic pad body is provided downwardly with a mounting hole for the insertion rod located below the bottom portion of the protruded stopper, the top portion of the insertion rod of the protruded stopper is extended to mount with a circular body having the top portion being extended with a circular protruded block is having a recessed hole, the protruded stopper and the elastic pad body are insertably and securely connected and the elastic pad body is mounted at the cavity hole of the rod of the screwdriver tip such that the circular protruded block is extended to the exterior of the cavity hole, such that when the rod of the screwdriver tip is inserted into the shaft of the screwdriver, a pointed member is urged at the recessed hole of the circular protruded block to urge the elastic pad body to retract, the retraction of the protruded stopper allows the top face of the circular protruded block to smoothly push to the interior of the rod body, and when the circular protruded block is pushed to the circular hole of the shaft body, the elastic pad body urges upward the protruded block is extended into the circular hole, and the circular body of the protruded stopper is exactly urged the inner face of the circular hole to stop the rod of the screwdriver tip from continuously inserted with the shaft body of the screwdriver shaft, and the screwdriver tip is fully insertably connected to the front end of the shaft body of the screwdriver shaft, thereby allowing the interchangeable of screwdriver tips.

2. An improved structure of a screwdriver tip as set forth in claim 1, wherein the elastic pad body is triangular shape made from rubber material, and the volume is slightly larger than that of the cavity hole, the elastic pad body is mounted into the cavity hole and the external face of the elastic pad body and the inner face of the cavity hole have a gap distance to allow the retraction and restoration of the elastic pad body.

3. An improved structure of a screwdriver tip as set forth in claim 1, wherein the diameter of the insertion rod at the bottom of the protruded stopper is larger than that of the mounting hole of the elastic pad body, thereby the insertion rod can securely insert at the mounting hole to allow the protruded stopper to securely secured at the elastic pad body.

4. An improved structure of a screwdriver tip as set forth in claim 1, wherein the diameter of the circular body is larger than the circular hole so that when the circular protruded block is inserted within the circular hole, the top face of the circular body can urge the circular edge within the circular hole so as to restrict the tip moves continuously.

5. An improved structure of a screwdriver tip as set forth in claim 1, wherein the circular edge at the top face of the circular block of the protruded block is provided with a slanting face, and the slanting face allows the circular block to smoothly slide beyond the end opening of the shaft body of the screw shaft and the circular hole
